(19) United States
(12) Patent Application Publication
(10) Pub. No.: US 2011/0087518 A1
(43) Pub. Date: Apr. 14, 2011

(54) Method for quantifying the relative value of movies prior to spending substantial amounts of money on full production thereof

(76) Inventor: Phillip Faller Schermer, Pittsburgh, PA (US)

(21) Appl. No.: 12/587,744

(22) Filed: Oct. 13, 2009

(51) Int. Cl. G06Q 50/00; G06Q 10/00; G06Q 40/00

(52) U.S. Cl. 705/7.29; 705/35

(57) ABSTRACT

This invention relates to methods for quantifying the relative value of a movie concept, script, treatment or other representation of a movie prior to spending substantial amounts of money on fully producing it. The decisions to make major investments in large budget movies and smaller investments in mid sized budget movies, and even to make what might be considered comparatively minor investments, such as by indie filmmakers—although not necessarily minor investments to the indie filmmakers—in what are small budget movies, are greatly enhanced by a method that allows for some quantitative feedback on the potential for success of a movie before the bulk of the investment in its full production is made. The present invention provides such methods, and does so through the use of “investment trailers,” or “ITs”, a movie trailer that is different from ones used to promote a movie after it has been produced. The purpose of ITs is to create a vehicle, at a very low price, that can be placed on the internet for viewing. By monitoring various market metrics, such as the numbers of views for each IT, and collecting data on the market performance of those movies that are ultimately produced and distributed, one can create a basis for comparison with future movies to allow for data-supported predictions about the potential for success of a given movie, and do so very fast, very inexpensively and reasonably accurately.

### CROSS-REFERENCE TO RELATED APPLICATIONS

None.

### STATEMENT REGARDING FEDERALLY SPONSORED RESEARCH OR DEVELOPMENT

None.

### NAMES OF THE PARTIES TO A JOINT RESEARCH AGREEMENT

None.

### BACKGROUND OF THE INVENTION

This invention relates to methods for quantifying the relative value of a movie concept, script, treatment or other representation of a movie prior to spending substantial amounts of money on fully producing it.

Historically, the processes by which investment decisions are made to fully produce a movie have been primarily instinctive and qualitative in nature. See Eliashberg, Hui and Zhang, The Wharton School, University of Pennsylvania, “From Story Line to Box Office: A New Approach For Green-Lighting Movie Scripts”, Management Science, Vol. 53, No. 6, June 2007, pp. 881-893 (“Movie studios often have to choose among thousands of scripts to decide which ones to turn into movies. Despite the huge amount of money at stake, this process—known as green lighting in the movie industry—is largely a guesswork based on experts' experience and intuitions.”), incorporated by reference herein.

The decision-making process typically has not been based on some reasonably reliable data or market metrics, or some other quantitative assessment of likely Return on Investment (“ROI”). The decision making process instead relies on individuals within the movie making industry who have developed a certain expertise in judging the potential for a movie to succeed. But those individuals (experts and non-experts), by and large, do not rely on extensive quantifiable data directed to the particulars of the movie in their decision making. Of course, to be most valuable, quantitative market metrics data would have to be available prior to the commitment being made to fund the full production costs of the film. This adds to the dilemma since any market testing of a movie has heretofore seemed to be capable of being performed only after the movie has already been made, and this defeats the objective of trying to decide which movies to underwrite before spending the vast amount of money that may be involved. This thinking has resulted in decision makers relying on factors such as the quality of the concept, script, treatment or other representation of a movie, the casting, the expected costs, the genre and current trends in successful moviemaking, in coming to a decision on whether to fund the production of a movie. Unfortunately, all of these considerations are relatively abstract and unspecific, and do not give the decision makers or those funding the project much feedback about likely market reaction to the movie at a time when such information would be most useful. While focus groups and the like are periodically used in the movie making industry, their use seems to be very limited. For example, choosing which of multiple endings to use in a movie may lend itself to focus groups and the like, but again this approach is only relevant after substantial sums of money have already been spent to producing the movie. In part as a result of the absence of quantitative measurement tools used in making the decision about whether to fund the full costs of making a movie (pre-production, production and post-production), there have been many well known examples of films that were exceedingly expensive to produce and yet were box office failures. See, for example, “The Adventures of Pluto Nash” (Budget of $90 to $100 million; Box Office Gross of $4.4 million); “Cutthroat Island” (Budget in excess of $100 million; Box Office Gross of $9.9 million); “Heaven's Gate” (Budget $44 million; Box Office Gross of $3 million). What is apparent from these and other examples known in the field is that certain experiential judgments about the likelihood of success of a movie, even when made by bona fide “experts” in the field, have simply been wrong, and sometimes they have been wrong to a degree that is dramatic.

This approach to decision making in the film industry means that significant amounts of money are being wagered on the potential for success of a movie with scant measurable data being used as part of the decision making equation. It is plain that the decision making process has heretofore inevitably included a healthy dose of sheer guessing. The tremendous investment risk associated with whether a movie concept, treatment, script or other representation of a movie will return a profit if a movie studio or other investors are willing to fund the full development of the concept/treatment, pay for a written script, and then undertake the efforts necessary to make a full production from it, has not historically been grounded on objective useful data. Nor has that approach that has been used been the method of choice because of its virtues. Instead, this approach has been merely tolerated as “the nature of the business.”

Reliance on this deeply flawed approach has been somewhat understandable because investors and studios heretofore have not been able to watch a movie or test-market it and then decide whether to fund it, since the funding is necessary to make the movie in the first place. Since the making of theatrical release movies is typically so expensive, and given that the “experts” are frequently wrong in their predictions, the movie studios have gone to a business model that greatly limits the number of medium to large budget movies that can be made by each studio in a given year, and to some degree has resulted in a small group of “bankable” leading actors and actresses (the so-called “A-list”) regularly getting leading roles, while an increasingly large number of talented actors and actresses go long periods without meaningful work. As a result, those actors and actresses who are not seen as “currently bankable” (at any given time, the “A-list” of bankable actors and actresses can change) often go without work of note for long periods or else take relatively minor roles in relatively minor movies just to keep in circulation within the industry and/or to make money to live on.

With the advent of ever more sophisticated film, digital and video cameras capable of emulating film, and laptop computers capable of high end editing of what is shot by such cameras, and capable of sending, receiving and playing DVDs or other digital downloads where the file is the size of a typical full length theater-released film (approximately 90 minutes), it has become easier and easier over the years for individuals or small groups of minimally capitalized entrepreneurs to band together to take a stab at making movies. These market forces have created a growth industry of “indie” films (an “indie” film as used herein meaning a film made through the efforts of individuals who are not aligned with—but who instead are independent of—a major movie studio). Due to these and other advances in the art of filmmaking that are known to persons of skill in this art, the capital needed to get the basic equipment necessary to put together a low budget film has fallen significantly over the years. In addition, with the ever-growing number of cable television and interne outlets for watching and/or buying movies, the need for content has created a demand for new movies to be produced, especially where the costs of making such movies are comparatively inexpensive. These and other factors, in turn, have contributed to an increase in the number of indie filmmakers and indie films being made each year.

Some of the underutilized actors and actresses who are not seen as bankable for a larger budget movie, as others in their field may perceive them to be, therefore, find that doing some indie film work provides a means to keep busy, make money and remain in the public eye. Yet these underutilized actors and actresses are often very talented and are ideal for the right roles in the right mid-sized to large budget movies, but such movies are not being made as often. These non-A-listers are not utilized extensively because the economics of the moviemaking industry still make it too risky to invest, say, $80 million on a movie where these “second tier” actors and actresses are playing the main roles. Instead, the movie studios, which are probably the organizations most frequently making large budget movies, gravitate to the A-listers because it is perceived that this group of actors and actresses consistently draw attendance figures for their movies that make it a relatively reasonable “bet” to invest that much money in a single movie. Such bankable actors and actresses can sometimes even turn a mediocre movie into a financial success by the sheer force of their presence in the movie, although others have argued that the identity of the talent in a movie has no effect on the movie's success or lack thereof. See Lacy Rose, “This Year's Superstar Flops,” Forbes.com, Dec. 9, 2008 (“Top-shelf funnyman Will Ferrell kicked off the year with box-office bomb “Semi-Pro” ($33.5 million US box office). Mere weeks later, Hollywood heavyweight George Clooney followed suit with a flop of his own, “Leatherheads” ($41 million global box office). And then the summer arrived and with it came A-lister Nicolas Cage's big-screen disappointment, “Bangkok Dangerous” ($39 million globally). The weak performances of these and other star-vehicles may be bombshells for some studio executives, but they come as no surprise to a growing cadre of academics studying the economics of film making and, more specifically, the bankability of stars. Their conclusion: Big stars don't guarantee big success, and their big salaries are seldom justified. S. Abraham Ravid, a professor of finance at Rutgers University and a visiting professor at the Wharton School of the University of Pennsylvania, looked at nearly 200 films exhibited between late 1991 and early 1993 and concluded that a film's star had no impact on the flick's rate of return. Nine years and several studies later, he says definitively: “Star participation has no statistical correlation with the success of a movie, no matter how you define ‘a star’ or how you define ‘success.’””).

### BRIEF SUMMARY OF THE INVENTION

Due to the shifting trends in the movie making industry described herein, there has become a long-felt need in the art to bring some element of objective measurable data to the process of making decisions about whether to fund the production of a movie. The decisions to make major investments in large budget movies and smaller investments in mid sized budget movies, and even to make what might be considered comparatively minor investments by indie filmmakers—although not necessarily minor investments to the indie filmmakers—in what are small budget movies, would be greatly enhanced by a method that allowed for some quantitative feedback on the potential for success of a movie before the bulk of the investment in its full production is made. The present invention provides such methods, and does so through the use of what I am calling “investment trailers,” or “ITs”. The purpose of ITs is to create a video vehicle, at a very low price, that can be placed on the internet for viewing. By monitoring various market metrics for the IT, such as the numbers of views or visits for each IT, answers to survey inquiries about levels of interest in paying to see the film, amount of time spent on the IT and other well-known metrics used in internet advertising today, and by collecting data on the market performance of those movies that are ultimately produced and distributed, one can create a database for comparison with future movies and do so very fast, very inexpensively and reasonably accurately. Such a database permits reasonable, evidence-based forecasting of the potential for success of a movie, and does so before the bulk of the expense in making the movie has been incurred. The number and type of market metrics can be extensive. See, for example, http://en-us.nielsen.com/tab/product_families/nielsen_netratings, for a description of some commonly measured internet metrics, the contents of said site incorporated by reference herein. See also U.S. Pat. No. 6,643,696, the disclosure of which is incorporated by reference herein.

In summary, and in no way intending to limit the alternative ways to employ the basic principles of my invention and still be within the scope of the claims set forth herein, one or more trailers are made for a given movie, where the production costs of the trailer can be tightly controlled and limited. Such control can be maintained through various means, such as limiting the amount of time that the actors are gathered for such purposes; limiting the amount spent on set and/or costume design; shooting parts of the trailer where the actors and actresses live or are located, instead of bringing all of them to one location, so that they are not sitting around for scenes that do not involve them and yet must be paid, etc. The IT or investment trailer can be made using the actors and actresses that have been cast, for example, by a single casting agent, or multiple actors/actresses, cast by multiple casting agents, may be used in multiple versions of investment trailers for the same film, in order to gauge audience reaction to different individuals playing the various roles in the movie or to gauge which scenes work most effectively in an investment trailer.

Once an investment trailer has been shot and edited, it is then uploaded to a website for public viewing. A website dedicated to helping indie and/or other filmmakers can be used for this purpose, as can a purely commercial website set up for other purposes or even a website such as You Tube®, so long as the website has a means for gathering market metrics on the movie. One important market metric, but not the only one contemplated herein, is measuring the number of views of the ITs or visits to the ITs. There are many different metrics that can be gathered for each movie, but some of the basic metrics could be the number of views or visits, the amount of time spent on a given movie's home page, answers to survey questions about the movie, and the like. While in the abstract there is no necessary correlation between various metrics such as the number of views of a given investment trailer and the movie's likelihood for success, my invention at least provides objective measures that would allow those contemplating an investment in a movie to compare the pre-production interest in the film with the pre-production interest in other films that have already been released and that have some known post-production market performance record (again, performance can be measured by different metrics, such as the attendance numbers for a theatrically released film or the amount of money generated by the sale or transfer of specific distribution rights for the film).

I provide one simplified example of how my invention may be implemented. Although this is a currently preferred embodiment of my invention, it in no way is meant to limit the scope of my claims. It is specifically contemplated that there are many ways to implement the invention that I have claimed herein. Suppose, for example, that Indie Movie A's investment trailer is on the selected website and has the highest number of views of the movies posted on the same site (say that number is 500,000 views). Suppose that Indie Movie A's budget for total costs to be made (e.g., pre-production, production and post-production) is $300,000. Suppose that all rights in Indie Movie A are thereafter sold to a distributor for $2 million. The metrics created by my invention are very useful in creating a baseline for comparison for other, later movies. My invention creates data that would be very useful in the producer of, say, Indie Movie B convincing third parties to invest in the production of the film. Suppose that the producer of Indie Movie B creates an investment trailer and it is posted on the same website as Indie Movie A. Suppose that Indie Movie B produces, say, 2,000,000 views. This data can be combined with other data and used by decision makers about whether to invest in Indie Movie B's full production. It can also be used by the producer of Indie Movie B to try to convince investors to invest in Indie Movie B. Assume that Indie Movie B has an estimated production budget of $600,000. These data points will allow an investor to reasonably conclude that with Indie Movie B's investment trailer having four times as many views (a rough measure of consumer interest) as Indie Movie A's investment trailer, and a budget double that of Indie Movie A, there is a reasonable likelihood that Indie Movie B will produce revenues of roughly two to four times (and possibly more) that amount produced by Indie Movie A. These metrics can be augmented by answers to basic survey questions asked along with the investment trailer that is posted to the dedicated or public website for reviewing movies before they are fully produced. The multiples given herein as an example translate to a reasonable-to-anticipate baseline gross of $4 to $6 million, thereby making Indie Movie B and its expense of $600,000 in the overall production costs a good ROI. This data can also provide movie producers (indie and otherwise) with a sales tool to get the movie funded or, in the case of small budget movies that may already be made, to generate investment for advertising and marketing in an effort to launch the movie.

While the example I have provided is entirely hypothetical, it is likely that data collected on produced movies will provide either a direct numeric correlation for other future movies whose ITs are posted or else an indirect correlation according to some formula or equation. Other data points can be used for assessing whether the rough proportionality of numbers given as an example herein is applicable in the general case or whether, for example, the proportionality between costs to produce and number of views, on one hand, and gross revenue generated, on the other hand, is exponential, logarithmic or fractional, or whether there is some other equation that roughly describes the expected revenue for a given budget number and number of views or other metrics. The website where the ITs are placed can be used not only for collecting other metrics on the potential of the movie, but can also be used as a site to raise capital directly. For example, accredited investors, as that term is used and understood in the securities law sense, can be directed to portions of the site where they can sign up to make a specific investment in the movie after viewing the IT and the related metrics collected by my website. Similarly, smaller individual investments can be made on the website. Such investments might be as low as $25, where the investor gets a ticket to see the movie when it comes out and also buys some form of share or other defined interest in the movie's proceeds. By giving viewers of the IT this type of investment opportunity, the proprietor of the website creates a very high interest level in the movie represented by the IT, and this in turn could generate much “word of mouth,” always an important ingredient in the success of a movie. See “Estimating Word-of-Mouth for Movies, The Impact of Online Movie Reviews on Box Office Performance,” Xiaoquon Zhang et al. MIT Sloan School of Management, incorporated by reference herein. See also, “Using Online Reviews as a Proxy of Word-of-Mouth for Motion Picture Revenue Forecasting,” Chrysanthos Dellarocas et al., MIT Sloan School of Management, incorporated by reference herein.

My invention addresses perhaps the most significant problem in the movie making industry today—the extremely high cost (absolute and relative) of making movies. This problem results in fewer movies being made and fewer actors getting good roles. Similarly, in the case of indie movies, the lack of meaningful funding for production and/or marketing is a recurring theme. This, too, limits the number of high quality productions that garner public acclaim from that realm of the movie making industry. In short, the lack of market feedback before the money is invested constrains the number of otherwise good movies that are made, since the investment risks are often very high and the expected ROI is often very low. This problem is exacerbated when unproven or only marginally successful script-writers, producers and non-A-List actors may be involved. Yet, this is almost always going to be the case with most indie productions. The money behind large budget films these days is typically interested in only the most bankable actors and actresses, and only the most bankable treatment/concept/script. And, despite the existence of experts in this field, as noted herein there are frequently times when the expert's recommendation to make a substantial investment proves terribly wrong. Similarly, there are times when all of the “experts” pass on a movie only to have the property succeed wildly when the public is exposed to it (see, for example, Slumdog Millionaire) For example, it would be too risky in the eyes of many in the movie funding business to make an $80 million budget film and not use an A-list actor or actress such as George Clooney, Nicholas Cage, Sean Penn, Meryl Streep, Tom Cruise, Angelina Jolie, Denzel Washington, John Travolta or the like, since actors and actresses like these have a long history of acting in high grossing blockbuster films. By using my invention, objective data from a market place would be created to allow all movies to be vetted for consumer interest before the full production or Marketing investment has to be made. As noted, my invention applies to large, medium and small budget films, and to smaller budget films that may be shot and completed but which lack funding for marketing. Even though there are many good indie films being made each year, and they have some public exposure, primarily through international film festivals, there is a real limit on the number of indie movies that are ever seen by a statistically significant sized audience. Through the use of my invention, ordinary consumers with some interest in moviemaking, and/or movies more generally, can easily monitor what is coming down the pipeline in the way of new movies and, at the same time, contribute to the creation of hard data that can influence whether they or other investors are willing to back a given film. They can also become an investor in the movie. As noted, in the case of a small budget film that is already produced, the invention can still be used to raise capital, but this time for advertising, marketing and distribution, costs that can easily exceed the production budget if a movie is going to be actively promoted.

The investment trailer is an important part of my invention. It differs from marketing trailers commonly used once a film has been fully produced (i.e., after pre-production, production and post-production). Marketing trailers are usually limited to 2½ minutes long (a fairly universal requirement of movie theaters), and they tend to show a sequence of big impact scenes not necessarily in the order they appear in the movie. The most fundamental difference between marketing trailers and ITs is that the former are excerpted from the movie after it has been produced, while the latter are specially created before the movie is fully produced, in order to assist a movie in attracting the requisite funding. ITs can be made in many different ways. One way that I see as a best mode is as a single day shoot. With careful planning of scene and talent sequence, travel and script excerpts, every key actor and actress to be in the film can be made to converge on a single location, with one long day being dedicated to filming all of the scenes necessary for making the IT. Enough footage could be gathered in one long day of shooting to assemble an effective investment trailer. By taking this approach, one collapses the costs of production into a fraction of what would be the overall costs in making the full movie. Thus, for example, $50,000 could be used as the budget necessary for an IT. The byproduct of this manageable budget is the IT, a tool that can be leveraged to attract, say, $10 to $50 million for the full budget of the film, once the data collected by my invention demonstrates that the film has a good potential ROI. Approaches such as this can control costs dramatically, accurately capture the essence of the film and yet be enough to produce a useful metric of consumer interest in at least the concept of a movie. The data points collected by use of the method of my invention can then be combined with the other information usually relied upon by those making investment decisions in the movie making industry.

### BRIEF DESCRIPTION OF THE DRAWINGS

FIG. 1 discloses one embodiment of the present invention comprising a method for quantifying the relative value of movies prior to spending substantial amounts of money on full production thereof.

FIG. 2 discloses one embodiment of the present invention comprising a method for quantifying the relative value of movies prior to spending substantial amounts of money on full production thereof where a potential investors considers the data generated by the method shown in FIG. 1.

FIG. 3 discloses one embodiment of the present invention comprising a method for quantifying the relative value of movies prior to spending substantial amounts of money on full production thereof where a film producer or other stakeholders in the film use the data generated by the method shown in FIG. 1 in an effort to attract financing for the movie.

### DETAILED DESCRIPTION OF THE INVENTION

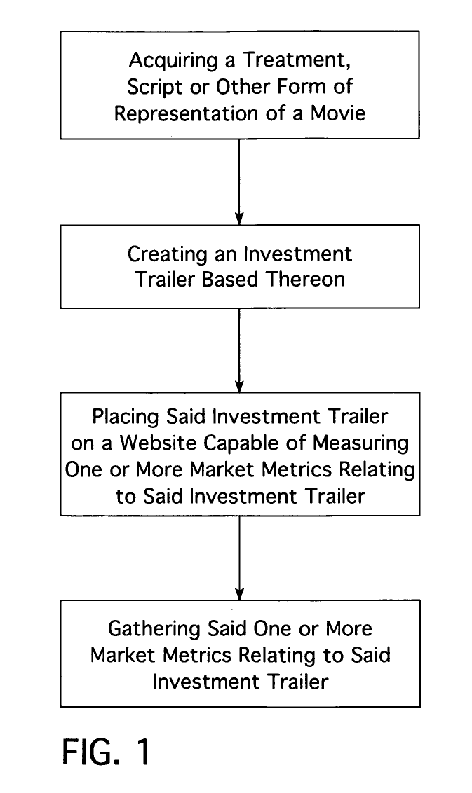

Referring to FIG. 1, the flow chart tracks the language of claims 1. The first step is “acquiring a treatment, script or other form of representation of a movie.” “Treatments” and “scripts” are understood terms of art in the field of screenwriting and movie making. My invention can be used with a treatment, an actual script or any other form of representation of a movie (such as a book, a television show, etc.). The only requirement is that the treatment, script or other representation be specific enough to allow for the creation of the IT as a derivative work. “Acquiring” in this context means to get rights to, to get electronic or physical possession of, or to otherwise control the property to a degree that you can use it for purposes of creating the IT. The second step is “creating an investment trailer based thereon.” This refers to the investment trailer that is at the heart of this invention. An investment trailer as used herein means a digital, video or film work that is capable of being electronically uploaded to an internet site for viewing, where its primary purpose is to create actual data that can be used in making decisions about whether to, or how much to, invest in a movie before a substantial amount of the movie's budget has already been spent. Several features are desirable for an IT though not absolutely necessary. First, the IT should be made in a relatively short period of time so as to control the costs of production. For example, with careful planning, the raw footage for an IT can be fully shot in one long day. Second, the IT should be representative of the storyline and highlight scenes of the movie. Third, the IT should include the main talent in the movie. Fourth, the IT could be shot with multiple cast lineups, thereby producing more than one option of an IT. For example, suppose that the dialogue and scenes in two ITs are the same, but the actors/actresses cast in the roles are varied. By placing these two ITs onto the same website, data could be collected on which actors draw a bigger audience. These qualities of an IT are cumulative, and the more ingredients that are used to make the IT simulate the finished movie, the more reliable the data generated in this process. The step of “placing said investment trailer on a website capable of measuring one or more market metrics relating to said investment trailer” is a well understood electronic process in today's world, and there are many ways to accomplish this step. One simple and well known way to accomplish this step is to post the investment trailer onto the You Tube® website. Another way to accomplish this step is to create a dedicated website, for example one for movie making and/or fundraising, and upload the investment trailer to said website. These and other approaches will be apparent to one skilled in the art. “Gathering said one or more market metrics relating to said investment trailer” is fairly straightforward in today's electronic commerce world. Software used on such a site, or a third party provider of such services, can be used to gather relevant market metrics. Sites such as You Tube® already calculate such metrics (including, but not limited to, visits of views), and in that case “gathering” may be an act as simple as reviewing such data or reviewing and recording such data. Additionally, page view counting is a well established means of gathering metrics in internet advertising, so this technology can be employed on a dedicated website. Other ways to “gather” such data as meant by this step are described herein and will be understood by those skilled in the art. The method shown in FIG. 1 might be thought of as being directed to a website that performs the listed steps.

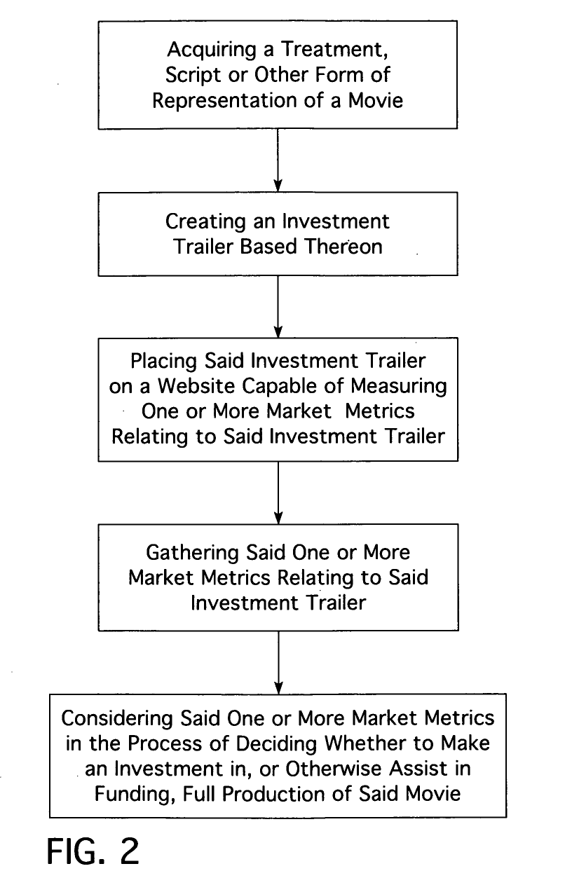

Referring to FIG. 2, it has the same steps as FIG. 1 but adds as the final step “considering such data in the process of deciding whether to make an investment in, or otherwise assist in funding, full production of a movie.” This step is referring to those who may be evaluating a possible investment into the full production of a movie and who are some of the beneficiaries of the objectively measurable market metrics data generated by my invention. Such an investor may be a movie studio, an indie film producer, a private equity firm, a private venture capital firm, an individual or even individuals of modest means who are being asked to back the production of a movie. In short, it can be anybody contemplating an investment of any type in a movie. The method shown in FIG. 2 might be thought of as being directed to the potential investors and the website that produces the data.

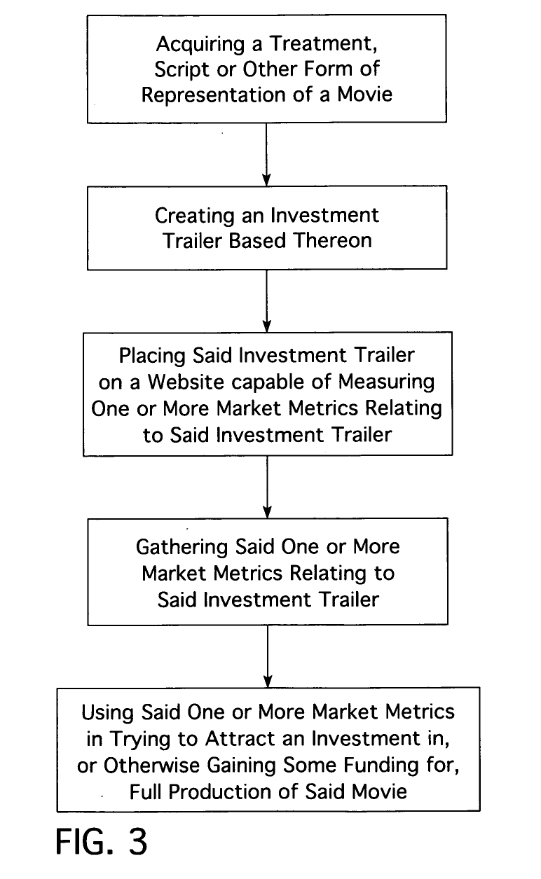

Referring to FIG. 3, it has the same steps as FIG. 2 except that it has a different last step, namely: “using such data in trying to attract an investment in, or otherwise gain some funding for, full production of a movie.” This step is referring to those who may be trying to convince others to make an investment into the full production of a movie and who therefore may also be seen as the beneficiaries of the objectively measurable market metrics data generated by my invention. Such an individual or business may be an early investor trying to attract additional investors, or the producer, or the creator, or the owner of the rights, or the author of the treatment/script or other representation of a movie. Such individuals and/or businesses typically need financial backing in order to fully produce a movie, and this sort of data can be a powerful tool in convincing others to make such an investment commitment. In sum, the method shown in FIG. 3 might be thought of as being directed to the potential film producers/backers and the website that produces the data.

While I have disclosed several variations of my invention herein, these are presently the preferred embodiments of my invention and in no way are these the only manners of carrying out my invention. The claims of this patent are specifically intended to embrace other variations of my invention that are within the scope and spirit and my invention.

What I claim is:

1. A method for quantifying the relative value of a movie prior to spending substantial amounts of money on full production of said movie, comprising the steps of:
acquiring a treatment, script or other form of representation of a movie;
creating an investment trailer based thereon;
placing said investment trailer on a website capable of measuring one or more market metrics relating to said investment trailer; and
gathering said one or more market metrics relating to said investment trailer.

2. A method for quantifying the relative value of a movie prior to spending substantial amounts of money on full production of said movie, comprising the steps of:
acquiring a treatment, script or other form of representation of a movie;
creating an investment trailer based thereon;
placing said investment trailer on a website capable of measuring one or more market metrics relating to said investment trailer;
gathering said one or more market metrics relating to said investment trailer; and
considering said one or more market metrics in the process of deciding whether to make an investment in, or otherwise assist in funding, full production of said movie.

3. A method for quantifying the relative value of a movie prior to spending substantial amounts on full production of said movie, comprising the steps of:
acquiring a treatment, script or other form of representation of a movie;
creating an investment trailer based thereon;
placing said investment trailer on a website capable of measuring one or more market metrics relating to said investment trailer;
gathering said one or more market metrics relating to said investment trailer; and
using said one or more market metrics in trying to attract an investment in, or otherwise gaining some funding for, full production of said movie.
